(19) United States
(12) Patent Application Publication
(10) Pub. No.: US 2005/0209408 A1
(43) Pub. Date: Sep. 22, 2005

(54) Star-shaped polymer, multiple star polymer and their preparation methods

(76) Inventors: Hyung-Jae Lee, Daejeon (KR); Kwan-Young Lee, Daejeon (KR); Nam-Sun Choi, Daejeon (KR); Seung-Hwa Lee, Daejeon (KR)

Correspondence Address: JACOBSON HOLMAN PLLC, 400 SEVENTH STREET N.W., SUITE 600, WASHINGTON, DC, 20004, US

(21) Appl. No.: 11/001,092

(22) Filed: Dec. 2, 2004

(30) Foreign Application Priority Data
Mar. 17, 2004 (KR) 10-2004-17883
Mar. 19, 2004 (KR) 10-2004-18650

(51) Int. Cl. C08F 2/00

(52) U.S. Cl. 525/242

(57) ABSTRACT

The present invention provides a method for preparing star polymer comprising the steps of: i) preparing for living polymer anion of M.W. 500˜500,000 by reacting anionic polymerization initiator with at least one monomer selected from the group consisting of styrene, α-methylstyrene, ο-methylstyrene, ρmethylstyrene, ρ-tert-butylstyrene, butadiene, isoprene and cyclohexadiene; ii) adding more than twice at least one linking agent selected from the group consisting of divinylbenzene, divinyltoluene, divinylbiphenyl and divinylnaphthalene; and iii) reacting said living polymer anion with said linking agent to prepare for star polymer. Further, this invention also provides a multiple star polymer with following formula 1; SₚX_{q}Aᵣ.

### BACKGROUND OF THE INVENTION

The present invention relates to a method for preparing star polymer. More particularly, the present invention relates to a method for preparing star polymer using anionic polymerization method by controlling the number of arms with minimum formation of insoluble gel and unreacted linear polymer as byproducts.

Furthermore, the present invention also relates to a multiple star polymer consisting of at least 2 star polymers having multiple arms and a preparation method thereof.

Star polymer can be classified as one of branched polymers and affords the higher melt flow index, lower viscosity and improved processibility compared to linear polymer. Anionically prepared star polymers are obtained by the reaction between living polymer anion and linking agent having multiple functional groups. The structure and the number of arms of star polymer can be controlled by the selection of linking agent and polymerization method.

While the linking agent having halogen functional group such as, SiCl₄, provides a star polymer of which arm number is determined by the number of ligands attached to linking agent, olefinic difunctional linking agent like divinylbenzene (DVB) affords a star polymer with higher arm number than the multiplicity of functional group

Divinylbenzene is a well-known linking agent having di-functional groups and n divinylbenzene can link in principle n+1 polymer chains together (Bauer, B. J.; Fetters, L. J. Rubber Chem. Technol., 51, p406, (1978)). However, the number of arms can be varied by cross-linking degree. If the relative amount of added divinylbenzene as to living polymer is small, unreacted linear polymer can be remained together with the formation of star polymer. On the other hand, insoluble gel is formed together with star polymer if the relative amount of divinylbenzene as to living polymer is large. The number of arms also depends on the kinds of anionic polymerization method, such as, arm-first method or core-first method.

Core-first method gives star polymer having large number of arms. This method has following steps; i) adding divinylbenzene to anionic polymerization initiator to form a microgel; and ii) adding monomers to form the polymer arms.

In U.S. Pat. No. 3,975,339, Burchard, W. disclosed the method for preparing gel polymer to form net-shape polymer with following steps; i) adding 0.5˜20 equivalent of divinylbenzene to initiator to prepare a microgel having 270 anions per each molecule; and ii) forming gel polymer having 270 arms. However, this gel polymer has physcial properties such as low processibility and insoluble property.

Tsitsilianis, C. has disclosed a star polymer having 22 to 1300 arms by adding styrene to anionic core formed from the reaction of initiator with divinylbenzene. Further, it has been reported that a stable microgel was formed by using 1.5˜2.5 equivalent of divinylbenzene as to initiator [Tsitsilianis, C. et. al. Macromolecules, 24, 5897 (1991)].

In U.S. Pat. No. 5,773,521, Hoxomeier, R. J. disclosed a core anion preparation method comprising the addition of 1:4 mixture of divinylbenzene and styrene monomer to initiator. Star polymer can be obtained by adding butadiene or isoprene to this core anion. It has been reported that this method for preparing star polymer is more effective in preparing core anion than the reaction of initiator with divinylbenzene only. However, core-first method can be hardly applied to industrial scale, due to the difficulty in controlling arms, the formation of insoluble gel polymer, leading to the inferior processibility and physical properties although the number of arms of star polymer be incresed by adding small amount of divinylbenzene.

Arm-first method is one of star polymer preparation methods which comprises the steps of; i) adding initiator to monomers to prepare for living arm polymer; and ii) adding divinylbenzene to afford star polymer. This method of star polymer gives no formation of gel polymer, but smaller number of arms.

Tsitsilianis, C. reported that 81% of star polymer having 15 arms and 19% of unreacted linear polymer can be obtained by addition of 3.5 equivalent of divinylbenzene to linear polystyrene having M.W. 3,500, and that 100% of star polymer having 11 arms can be obtained by addition of 6 equivalent of divinylbenzene to linear polystyrene having M.W. 11,000 [Tsitsilianis, C. et. al. Eur. Polymer. J. 27, 243 (1991)]. Further, Fetters, L. J. also reported that 90% of star polymer having 6 arms and 9% of unreacted linear polymer can be obtained upon adding 3.3 equivalent of divinylbenzene to linear polyisoprene having M.W. 5,000, and that 97% of star polymer having 14 arms can be obtained upon adding 6.8 equivalent of divinylbenzene to linear polybutadiene having M.W. 5,500 [Young, R. N.; Fetters, L. J. Macromolecules, 11, 899 (1978)].

Further, Fetters, L. J. reported that star polymer having 5 arms can be obtained upon addition of 3 equivalent of divinylbenzene to polystyrene-polyisoprene copolymer having M.W. 70,000, and that star polymer having 6 arms can be obtained upon addition of 4 equivalent of divinylbenzene to polystyrene-polybutadiene copolymer having M.W. 30,000 [Bi, L.-K.; Fetters, L. J. Macromolecules, 9, 732 (1976)]. Wang, T.-Y. also reported that 81˜82% of star polymer having 7, 9, 11 arms and 18˜19% of unreacted linear polymer can be obtained when 4, 6, or 8 equivalent of divinylbenzene is added, respectively, to polystyrene-polyisoprene copolymer having M.W. 16,000 [Wang, T.-Y. et. al. J. Appl. Polym. Sci. 79, 1838 (2001)]. In U.S. Pat. No. 3,949,020, Prudence, R. T. disclosed that less than 5% of insoluble gel was formed when 5 equivalent of divinylbenzene was added to polystyrene-polybutadiene anion. On the other hand, in U.S. Pat. No. 5,458,791, Rhodes, R. B. disclosed that 3 equivalent of divinylbenzene was added to polyisoprene-polystyrene-polyisoprene triblock copolymer anion to give star polymer without the formation of insoluble gel polymer.

Although 2˜30 equivalent of divinylbenzene as to living polymer anion is used for converting unreacted linear polymer into star polymer, the resulted star polymer has a various arm number depending on the experimental condition and either unreacted linear polymer or insoluble gel polymer are present as by-product (Hsiesh, H. L.; Quirk, R. P. “Anionic principles and practices”, Marcel Dekker, New York, 1996, Chap. 13). Addition of large amount of divinylbenzene to living block polymer gives a large amount of insoluble gel which causes the decline of processibility, while a large amount of unreacted linear polymer is formed upon the addition of small amount of divinylbenzene. Therefore, with previous synthetic methods, it is hard to prepare for pure star polymer and to control the number of arms of star polymer.

Multiple star polymer, consisting of more than 2 star polymers, has larger number of polymer arms compared to star polymer. Most of multiple star polymers have been reported as the structure of star-linear-star or star-star.

Generally, star-linear block polymer has a structure in which two star polymers having multiple arms are linked with linear polymer. Star-linear block polymers involve H-shaped, π-shaped, super-H-shaped, star-linear, star-star, and star-linear-star (so called, dumbell form or pom-pom form) polymers. Especially, star-linear-star polymers have been prepared by the methods of i) coupling star-linear polymer by adding silylchloride coupling agent; or ii) attaching 2 star polymers to the both ends of linear polymer.

Hadjichristidis, N. reported that bis(polyvinylethylene-b-polystyrene), a precursor of star-linear-star can be prepared by following steps of; i preparing polyvinylethylene anion from butadiene; ii) preparing polyvinylethylene-polystyryl anion by the addition of styrene to polyvinylethylene anion; and iii) preparing bis(polyvinylethylene-b-polystyrene) by the addition of dichlorodimethylsilane to polyvinylethylene-polystyrene anion. Further, it has been reported that star-linear-star can be prepared by following steps of; i) preparing bis(2-dimethylchloroethylethylene-b-poly-styrene) by hydrosilylation of vinyl group in the presence of Pt catalyst; and ii) preparing star-linear-star by the addition of polybutadiene anion ½ shorter than linear polymer (Houli, S.; Iatrou, H.; Hadjichristidis, N.; Vlassopoulos, D. Macromolecules, 35, 6592, 2002).

Hirao, A. reported that star-linear-star polymer can be prepared by following steps of; i) preparing precursor of star-linear-star by introducing benzylbromide to both ends of linear polystyrene; and ii) preparing star-linear-star polymer by adding polystyryl anion ⅕ shorter than linear polymer (Haraguchi, N.; Hirao, A. Macromolecules, 36, 9364, 2003).

Above examples for preparation of star polymer suggest the precursor polymer in which functional groups capable to form star structure are connected by linear polystyrene chain. Accordingly, the use of precursor which can be easily converted to branched structure is important. However, the number of stars connected is difficult to increase since above star-linear-star polymer has a dumbell shape having linear chain connected with two stars.

Knauss, D. M. reported star-linear-star polymer prepared by following steps of; i) addition of chlorodimethylsilystyrene to living polystyryl anion to give star polymer; ii) addition of styrene monomers to star polymer to afford star-linear polymer; and iii) addition of dichloromethylsilane to star-linear polymer to prepare star-linear-star polymer. The prepared star-linear-star polymer has a linear chain polymer 6˜20 times longer than branch polymer connected to the star core (Knauss, D. M.; Huang, T. Macromolecules, 35, 2055, (2002); Macromolecules, 36, 6036, (2003)).

Jackson, C. reported that the addition of styrene monomer to star polymer, which is prepared by adding divinylbenzene to living polystyryl anion gave asymmetric star polymer together with a little amount of coupled star (Frater, D. J.; Mays, J. W.; Jackson, C. J. of Polym. Sci: Part B: Polymer Physics, 35, 141, (1997)).

Majyjaszewski, K. reported the preparation of star shaped polystyrene by polymerization of styrene in the presence of CuBr/2,2′-bipyridine through ATRP (atom transfer radical polymerization) process followed by linking reaction with 5˜15 equivalent of divinylbenzene to give star polymer, which was slowly converted into coupled star polymer through star-star coupling during longer reaction time (Xia, J.; Zhang, X.; Majyjaszewski, K. Macromolecules, 32, 4482, (1999)).

Star polymer with a structure of star-linear-star has been synthesized so far, but the synthesis of star-star polymer or multiple star polymer by using linking agent has not been reported yet. Further, the suggested preparation method of star-linear-star polymer is hard to be applied in the industry due to its complicated preparation method and unsuitable to synthesize multiple star polymer.

In the present invention, star-shaped polymers such as star- or multiple star polymer can be readily prepared using only small amount of linking agent. Star-shaped polymers of the present invention can be anionically prepared by the incremental addition of linking agent to initial chain polymer. Further, the synthetic method of star-shaped polymers of present invention can minimize unreacted polymer and control the number of branches without the formation of insoluble gel.

### SUMMARY OF THE INVENTION

The first object of the present invention is to provide a method for preparing star polymer comprising the steps of:

i) preparing for living polymer anion having molecular weight of 500˜500,000 from reaction of polymerization initiator with at least one monomer selected from the group consisting of styrene, α-methylstyrene, o-methylstyrene, p-methylstyrene, p-tert-butylstyrene, butadiene, isoprene and cyclohexadiene;

ii) repeatedly adding more than twice at least one linking agent selected from the group consisting of divinylbenzene, divinyltoluene, divinylbiphenyl and divinylnaphthalene to prepare star polymer.

Desirable monomer for the present invention is at least one selected from the group consisting of styrene, butadiene and isoprene.

Desirable polymerization initiator for the present invention is at least one selected from the group consisting of n-butyllithium, sec-butyllithium, tert-butyllithium, methyllithium and ethyllithium.

Further, desirable polymerization initiator is n-butyllithium.

Desirable linking agent for the present invention is divinylbenzene.

Further, desirable living polymer anion is at least one selected from the group consisting of polystyrene-polybutadiene block copolymer, polystyrene-polyisoprene block copolymer, styrene-butadiene random copolymer and styrene-isoprene random copolymer.

The total amount of linking agent is 0.2˜10 equivalent relative to living polymer anion and the each amount of linking agent per one addition is 0.1˜2 equivalent relative to living polymer anion.

The molecular weight of preferable living polymer anion is 2,000˜200,000 and the molecular weight of preferable star polymer is 10,000˜5,000,000.

The second object of the present invention is to provide a multiple star polymer with following formula 1;
SₚX_{q}Aᵣ (1)
wherein,

S is a star polymer represented by formula Aₘ-Xₙ,

A is polymer branch having molecular weight of 500˜100,000,

X is a linking agent represented by formula (Y-Z-Y),

[Y is a vinyl group in the form of (—CR₁═CR₂R₃), wherein R₁, R₂ or R₃ is each independently H, C 1˜20 alkyl, Z is an aromatic compound, such as benzene, biphenyl, toluene or naphthalene]

m is an integer of 3˜100, n is an integer of 1˜100,

whereas 0.1<n/m<10,

p is an integer of 2˜1000, q is an integer of 2˜100,

r is an integer of 0˜100, whereas (p+r)<q.

Said polymer arm is a homopolymer selected from the group consisting of polystyrene, poly(α-methylstyrene) poly(o-methylstyrene), poly(p-methylstyrene), poly(p-tert-butylstyrene), polybutadiene, polyisoprene and polycyclohexadiene. Said polymer arm can be also a copolymer polymerized from at least two monomers selected from the group of vinyl aromatic monomer, such as, styrene, α-methylstyrene, o-methylstyrene, p-methylstyrene, p-tert-butylstyrene and conjugated-diene monomer, such as, butadiene, isoprene, cyclohexadiene.

Said copolymer can be a block copolymer with more than 2 polymer blocks selected from polystyrene block, polybutadiene block or polyisoprene block. Said copolymer can be also a random copolymer with more than 2 monomers selected from styrene, butadiene or isoprene. On the other hand, preferred homopolymer can be polystyrene, polybutadiene or polyisoprene.

Said linking agent can be at least one selected from the group consisting of divinylbenzene, divinyltoluene, divinylbiphenyl and divinylnaphthalene.

Further, the present invention provides a process for preparing multiple star polymer represented by formula 1 comprising the steps of:

i) preparing living polymer anion with molecular weight of 500˜100,000 from the addition of anionic polymerization initiator to at least one monomer selected from the group consisting of vinyl aromatic monomer, such as, styrene, α-methylstyrene, o-methylstyrene, p-methylstyrene, p-tert-butylstyrene and conjugated-diene monomer, such as, butadiene, isoprene, cyclohexadiene;

ii) preparing living star polymer anion by the incremental addition of the linking agent of formula (Y-Z-Y) to obtained living polymer anion; and

iii) preparing multiple star polymer by adding more than once the linking agent of formula (Y-Z-Y) to obtained living star polymer anion.
SₚX_{q}Aᵣ (1)
wherein,

S is a star polymer represented by formula Aₘ-Xₙ,

A is polymer arm of M.W. 500˜100,000,

X is a linking agent represented by formula (Y-Z-Y),

[Y is a vinyl group in the form of (—CR₁═CR₂R₃), wherein R₁, R₂ or R₃ is each independently H, C 1˜20 alkyl, Z is an aromatic compound, such as benzene, biphenyl, toluene or naphthalene]

m is an integer of 3˜100, n is an integer of 1˜100,

whereas 0.1<n/m<10,

p is an integer of 2˜1000, q is an integer of 2˜100,

r is an integer of 0˜100, whereas (p+r)<q.

Said anionic polymerization initiator can be at least one selected from the group consisting of n-butyllithium, sec-butyllithium, tert-butyllithium, methyllithium and ethyllithium. The amount of linking agent can be 0.1˜3 molar equivalent as to living polymer anion.

The molecular weight of said living polymer anion can be 1,000˜20,000. The amount of linking agent can be 0.1˜2 molar equivalent as to living polymer anion.

### BRIEF DESCRIPTION OF THE DRAWINGS

FIG. 1 shows gel permeation chromatogram of star polymer (A, B, C) prepared according to the methods of Example 1 by incremental addition of divinylbenzene to polystyryl anion of M.W. 26,000.

It also shows gel permeation chromatogram of star polystyrene (D, E, F) prepared from one shot addition of divinylbenzene to polystyryl anion of M.W. 26,000 according to the methods of Comparative Example 1.

FIG. 2 shows gel permeation chromatogram of star polystyrene (A, B, C) prepared from incremental addition of divinylbenzene to polystyryl anion of M.W. 12,000 according to the methods of Example 2.

It also shows gel permeation chromatogram of star polystyrene (D, E, F) prepared from one shot addition of divinylbenzene to polystyryl anion of M.W. 12,000 according to the methods of Comparative Example 2.

FIG. 3 shows gel permeation chromatogram of multiple star polystyrene having M.W. 13,500 prepared from the reaction of divinylbenzene with living star polystyryl anion according to Example 4. A shows a star polystyrene and B or C shows multiple star polystyrene.

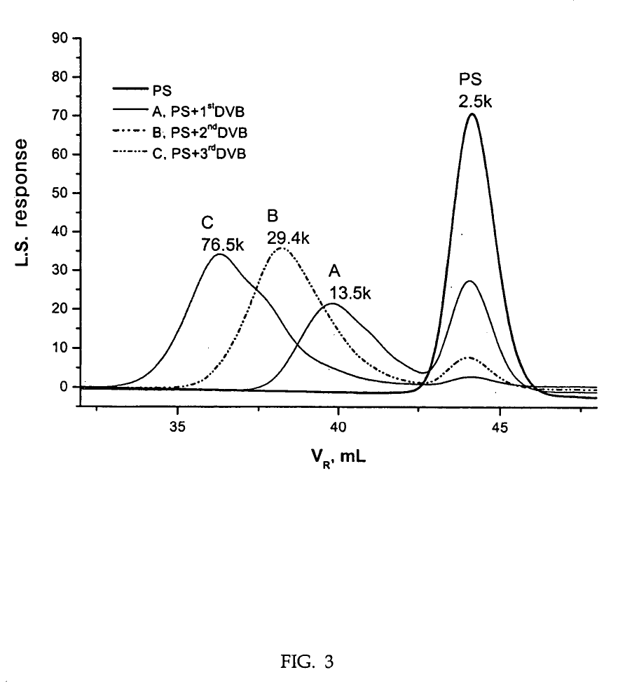

FIG. 4 shows gel permeation chromatogram of multiple star polymer having M.W. 81,000 prepared from the reaction between linking agent, divinylbenzene and living star polymer anion according to Example 6. A shows a star polymer and B or C shows multiple star polymer.

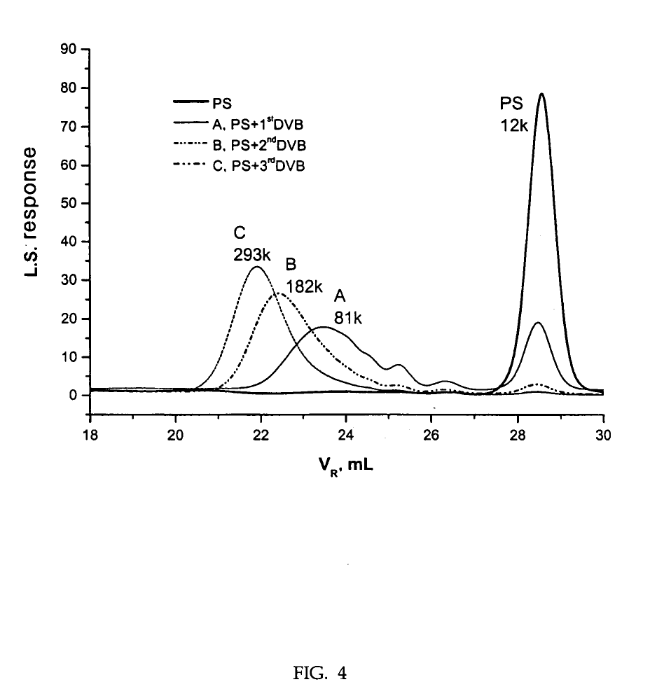

### DETAILED DESCRIPTION OF THE INVENTION

The method for the preparation of star polymer of the present invention comprises the steps of:
i) preparing living polymer anion having molecular weight of 500˜500,000 by reacting anionic polymerization initiator with at least one monomer selected from the group consisting of styrene, α-methylstyrene, o-methylstyrene, p-methylstyrene, p-tert-butylstyrene, butadiene, isoprene, and cyclohexadiene;
ii) repeatedly adding more than twice at least one linking agent selected from the group consisting of divinylbenzene, divinyltoluene, divinylbiphenyl and divinylnaphthalene to prepare star polymer.

The present invention provides a method for preparing star polymer in high yield, with controlled number of arms and minimized unreacted linear polymer without the formation of insoluble gel polymer.

The linking agent is at least one selected from the group consisting of divinylbenzene, divinyltoluene, divinylbiphenyl and divinylnaphthalene.

The monomer for this invention is at least one belonged to vinyl aromatic monomer or conjugated-diene monomer. The examples of monomers can be at least one selected from the group consisting of styrene, α-methylstyrene, o-methylstyrene, ρ-methylstyrene, ρ-tert-butylstyrene, butadiene, isoprene and cyclohexadiene. The preferable monomer is styrene, butadiene or isoprene. The most preferred monomer is styrene.

The anionic polymerization initiator is at least one selected from the group consisting of n-butyllithium, sec-butyllithium, tert-butyllithium, methyllithium and ethyllithium. The preferred initiator is n-butyllithium.

The reaction solvent is n-hexane, cyclohexane or heptane. The preferred solvent is cyclohexane.

The anionic polymerization promoter can be used to facilitate the anionic polymerization reaction to take place. The example of promoter can be at least one selected from the group consisting of tetramethylethylenediamine, dipiperidinoethane, hexamethylphosphoric triamide, ethylether, polyether having the structure of R(OCH₂CH₂)ₙOR′ [wherein R, R′ is alkyl, n is an integer of 1˜20] and tetrahydrofuran (THF). The preferred promoter is tetrahydrofuran.

Living polymer is prepared though anionic polymerization by adding initiator to monomer. Homopolymer or copolymer can be prepared.

The example of homopolymer can be polystyrene, poly(α-methylstyrene), poly(o-methylstyrene), poly(ρ-methylstyrene), poly(ρ-tert-butylstyrene), polybutadiene, polyisoprene or polycyclohexadiene. The preferred polymer is polystyrene, polybutadiene or polyisoprene.

Copolymer can be a random copolymer or a block copolymer. Random copolymer can be prepared by addition of anionic initiator to a mixture of more than two monomers. Preferred random copolymer comprises polymer of at least two monomers selected from styrene, butadiene or isoprene. The most preferred random copolymer is styrene-butadiene random copolymer, styrene-isoprene random copolymer or styrene-isoprene-butadiene random copolymer.

Block copolymer can be prepared by sequential addition of each monomer, in which the second monomer is added after first monomer is polymerized. Preferred block copolymer comprises at least two polymer blocks selected from polystyrene block, polybutadiene block or polyisoprene block. The most preferred block copolymer is [polystyrene-block-polybutadiene] or [polystyrene--block-polyisoprene].

The molecular weight of living polymer anion is 500˜500,000. Preferred molecular weight is 10,000˜300,000.

Linking agent is required to prepare star polymer from living polymer anion. The example of linking agent can be divinylbenzene, divinyltoluene, divinylbiphenyl or divinylnaphthalene. Preferred linking agent is divinylbenzene. The total amount of linking agent is 0.1˜10 molar equivalent as to the living polymer anion. The amount of linking agent used for each addition is 0.1˜2 molar equivalent as to living polymer anion and preferred amount of linking agent used for each addition is less than 1 molar equivalent as to the living polymer anion.

The addition of linking agent to living polymer anion can be in a repeated manner and the amount of linking agent per each addition can be same or different. The same amount of linking agent per each addition is desirble.

The star polymer prepared by the reaction of linking agent and living polymer anion has a structure of linked arms derived from living polymer anion. The number of arms is more than 3. The molecular weight of star polymer is 10,000˜5,000,000, preferably, 30,000˜3,000,000.

After dissolving the monomers in non-polar solvent, such as, cyclohexane, living polymer anion can be prepared from the reaction with initiator. Then, primary star polymer can be prepared by 1st addition of less than 1 equivalent of divinylbenzene to living polymer anion. At this time, unreacted living polymer anion can be present together. Secondary star polymer can be obtained by 2nd addition of divinylbenzene to the mixture of primary star polymer anion and unreacted living polymer anion. Further, tertiary star polymer can be obtained by 3rd addition of divinylbenzene. Star polymer having 3˜100 arms can be prepared in the yield of more than 95% without the formation of insoluble gel according to the method described above.

Following is one example of the method for preparing star polymer of present invention.

Living polystyryl anion of M.W. 26,000 is prepared by reaction of styrene with n-butyllithium for 30 minutes at room temperature. Incremental addition of divinylbenzene to living polystyryl anion twice gives star polymer having 12 arms in the yield of 93%. Star polymer having 26 arms is prepared in the yield of 98% upon adding divinylbenzene to obtained living polystyryl anion 5 times, as shown in Table 2. Incremental addition of divinylbenzene to obtained living polystyrene anion 7 times, star polymer having 34 arms is prepared in the yield of 99%, as shown in Table 2. Each amount of divinylbenzene used here is 0.74 equivalent relative to living polystyryl anion. The total amount of divinylbenzene used is 1.5, 3.7, 5.2 equivalent, respectively. As shown above, repeated addition of divinylbenzene leads to a almost full conversion of living polymer anion in preparing a star polymer.

Therefore, the present invention provides a method for preparing star polymer using only small amount of divinylbenzene with high conversion and controlled number of branches. Further, formation of gel polymer is avoided, since unreacted olefinic functional group (vinylstyrene) of divinylbenzene moiety in star polymer is minimized by the reaction with living polymer anion.

The multiple star polymer of the present invention is represented by the following formula 1;
SₚX_{q}Aᵣ (1)
wherein,
S is a star polymer represented by formula Aₘ-Xₙ,
A is a polymer branch of molecular weight of 500˜100,000,
X is a linking agent represented by formula (Y-Z-Y),
[Y is a vinyl group in the form of (—CR₁═CR₂R₃), wherein R₁, R₂ or R₃ is each independently H, C 1˜20 alkyl, Z is an aromatic compound, such as benzene, biphenyl, toluene or naphthalene]
m is an integer of 3˜100, n is an integer of 1˜100,
whereas 0.1<n/m<10,
p is an integer of 2˜1000, q is an integer of 2˜100,
r is an integer of 0˜100, whereas (p+r)<q.

The multiple star polymer of the present invention has a structure consisting of more than 2 star polymers.

As shown in formula 1, multiple star polymer of the present invention is consisted of more than two of star polymers with the same or different molecular weight. In the multiple star polymer, extra polymer arm A can be present. In formula 1, star polymer means that it has more than 3 polymer arms represented by Aₘ-Xₙ.

Said polymer arm can be a homopolymer or a copolymer. Preferred homopolymer can be selected from the group consisting of polystyrene, poly (α-methylstyrene) poly(o-methylstyrene), poly(p-methylstyrene), poly(p-tert-butylstyrene), polybutadiene, polyisoprene and polycyclohexadiene. The most preferred homopolymer is polystyrene, polybutadiene or polyisoprene.

Said polymer arm also can be a copolymer of monomer group of vinyl aromatic monomer, such as, styrene, α-methylstyrene, o-methylstyrene, p-methylstyrene, p-tert-butylstyrene and conjugated-diene monomer, such as, butadiene, isoprene, cyclohexadiene. Said copolymer can be a block copolymer or a random copolymer.

Said block copolymer has at least 2 polymer blocks selected from polystyrene block, polybutadiene block or polyisoprene block. Preferred block copolymer can be [polystyrene-block-polybutadiene] or [polystyrene-block-polyisoprene]. On the other hand, preferred random copolymer can be styrene-butadiene random copolymer, styrene-isoprene random copolymer or styrene-isoprene-butadiene random copolymer.

The molecular weight of polymer arm can be 500˜100,000. Preferred molecular weight of polymer arm can be 1,000˜20,000.

Said linking agent can be at least one selected from the group consisting of divinylbenzene, divinyltoluene, divinylbiphenyl and divinylnaphthalene. Preferred linking agent is divinylbenzene.

According to the invention, the process for preparing multiple star polymer represented by formula 1 comprises the steps of:
i) preparing living polymer anion with molecular weight of 500˜100,000 by the addition of anionic polymerization initiator to at least one monomer selected from the group consisting of vinyl aromatic monomer, such as, styrene, α-methylstyrene, o-methylstyrene, p-methylstyrene, p-tert-butyl-styrene and conjugated-diene monomer, such as, butadiene, isoprene, cyclohexadiene;
ii) preparing living star polymer anion by the addition of the linking agent of formula (Y-Z-Y) to obtained living polymer anion; and
iii) preparing multiple star polymer by adding more than once the linking agent of formula (Y-Z-Y) to obtained living star polymer anion.
   SₚX_{q}Aᵣ (1)
   wherein,
S is a star polymer represented by formula Aₘ-Xₙ,
A is a polymer branch of M.W. 500˜100,000,
X is a linking agent represented by formula (Y-Z-Y),
[Y is a vinyl group in the form of (—CR₁═CR₂R₃), wherein R₁, R₂ or R₃ is each independently H, C 1˜20 alkyl, Z is an aromatic compound, such as benzene, biphenyl, toluene, or naphthalene]
m is an integer of 3˜100, n is an integer of 1˜100,
whereas 0.1<n/m<10,
p is an integer of 2˜1000, q is an integer of 2˜100,
r is an integer of 0˜100, whereas (p+r)<q.

The process for preparing multiple star polymer of the present invention comprises i) preparing living polymer anion from the addition of anion polymerization initiator to monomer; ii) preparing living star polymer anion from the addition of the linking agent of formula (Y-Z-Y) to obtained living polymer anion; and iii) preparing multiple star polymer by the addition of linking agent of formula (Y-Z-Y) to obtained living star polymer anion.

Further, the process for preparing multiple star polymer of the present invention can minimize unreacted polymer and control the number of arm without the formation of insoluble gel.

Said monomer shall be the monomer used for anionic polymerization, for example, vinyl aromatic monomer, such as, styrene, α-methylstyrene, o-methylstyrene, p-methylstyrene, p-tert-butylstyrene and conjugated-diene monomer, such as, butadiene, isoprene, cyclohexadiene. Preferred monomer can be styrene, butadiene or isoprene.

Said anionic polymerization initiator can be at least one selected from the group consisting of n-butyllithium, sec-butyllithium, tert-butyllithium, methyllithium and ethyllithium. Preferred initiator can be n-butyllithium.

Solvent can be used for anionic polymerization among monomers and initiators. Nonpolar solvent, such as, n-hexane, cyclohexane or heptane can be used. The preferred solvent is cyclohexane. The anionic polymerization promoter can be used to enhance the anionic polymerization reaction. The example of promoter can be at least one selected from the group consisting of tetramethylethylenediamine, dipiperidinoethane, hexamethylphosphoric triamide, ethylether, polyether having the structure of R(OCH₂CH₂)ₙOR′ [wherein R, R′ is alkyl, n is an integer of 1˜20] and tetrahydrofuran (THF). The preferred promoter is tetrahydrofuran.

Living polymer can be prepared by anionic polymerization by adding initiator to monomer. Homopolymer or copolymer can be prepared.

The example of homopolymer can be polystyrene, polybutadiene or polyisoprene.

Copolymer can be a random copolymer or a block copolymer. Random copolymer can be prepared from the addition of more than 2 monomers simultaneously in anionic polymerization reaction. Preferred random copolymer comprises at least 2 monomers selected from styrene, butadiene or isoprene. The most preferred monomer copolymer is styrene-butadiene random copolymer, styrene-isoprene random copolymer or styrene-isoprene-butadiene random copolymer.

Block copolymer can be prepared from the subsequent addition of each different monomers, that is, the polymerization of first monomer followed by the addition of second monomer. Preferred block copolymer comprises at least 2 blocks selected from polystyrene block, polybutadiene block or polyisoprene block. The most preferred block copolymer is [polystyrene-block-polybutadiene] or [polystyrene-block-polyisoprene].

The molecular weight of living polymer anion is 500˜100,000. Preferred molecular weight is 1,000˜20,000.

Linking agent is required to prepare star polymer from living polymer anion. Linking agent is used for coupling living polymer anions. The example of linking agent can be divinylbenzene, divinyltoluene, divinylbiphenyl or divinylnaphthalene. Preferred linking agent is divinylbenzene.

The total amount of linking agent is 0.1˜3 molar equivalent relative to living polymer anion. Preferred amount of linking agent per living polymer anion is 0.1˜2 molar equivalent.

Living star polymer anion can be prepared by the reaction of living polymer anion with linking agent. The number of arm of star polymer shall be more than 3, preferably 3˜10. Multiple star polymer can be prepared by the incremental addition of linking agent to living star polymer anion. The number of addition of linking agent to star polymer anion is more than 1, preferably 1˜10.

The addition of linking agent to living star polymer anion can be carried out in a repeated manner and the amount of linking agent per each addition can be same or different. The same amount of linking agent per each addition is desirable.

In the present invention, the linking agent has at least two olefin functional groups and reacts with living star polymer anion to give a star polymer anion having poly(vinylstyrene) moiety capable to react with another molecule of living star polymer anion. Therefore, anionic site and styrenic functionality of the resulted star polymer anion can be utilized combine living star polymer anions. Star-star coupling can be more efficiently accomplished compared to the conventional method in which styrene monomer is added to grow anionic polymer chain as shown for the preparation of star-linear-star polymer.

Multiple star polymer can be prepared by following steps; i dissolving monomers in non-polar solvent, such as, cyclohexane; ii) the addition of initiator to the monomers to prepare living polymer anion; and iii) the addition of less than 1 equivalent of divinylbenzene to said living polymer anion to prepare for star polymer. Further, coupled star polymer, such as, star-star can be prepared by the addition of the same amount of divinylbenzene to star polymer. Then, quadruple star polymer, which is consisted of two coupled star polymers, can be prepared by the addition of the same amount of divinylbenzene to coupled star polymer. As described above, the synthetic method of multiple star polymer can minimize the amount of unreacted polymer up to less than 5% in star- or star-star polymers without the formation of insoluble gel. In other words, multiple star polymer can be prepared in the yield of more than 95% by more than twice addition of linking agent to living polymer anion, which prepared from the reaction of monomers with initiators.

Multiple star polymer represented by formula 1 can be prepared by a following exemplary method.

After preparing polystyrene anion of M.W. 2,800 by reaction of styrene with n-butyllithium at room temperature, 0.71 equivalent of divinylbenzene is added to living polystyrene anion. Then, star polymer having 5 arms is prepared. Then, 0.71 equivalent of divinylbenzene is added to obtained star polymer to prepare for multiple star polymer having 13 arms. In the same way, 0.71 equivalent of divinylbenzene is added to obtained star polymer to prepare for a quadruple star polymer having 33 arms. The amount of divinylbenzene used in each step is 0.71 equivalent relative to living polystyrene and the total amount of divinylbenzene used in this reaction is 2.1 equivalent.

The present invention suggests the preparation method of multiple star polymer in high yield with minimized content of unreacted polymer arm by utilizing reactive olefin functional group in poly(vinylstyrene) moiety resulted from the reaction of living star polymer anion and divinylbenzene.

The present invention can be explained by following examples. However, the scope of present invention shall not be limited by following examples.

### EXAMPLES

### Comparative Example 1

### Star Polystyrenes Prepared by One Shot Addition of Divinylbenzene (DVB)

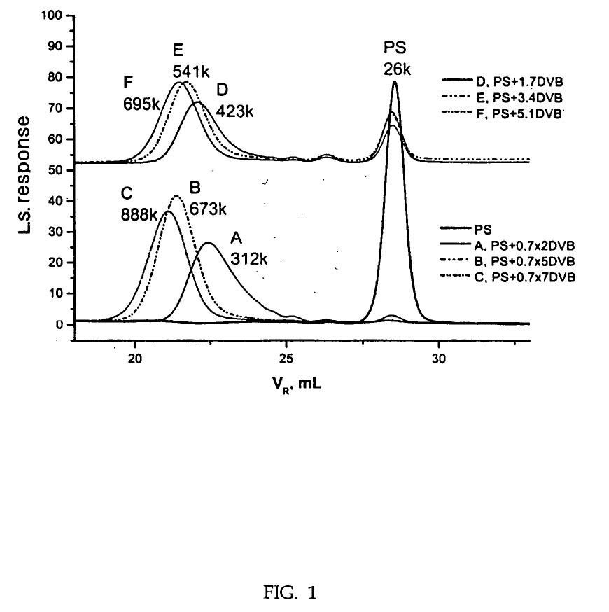

Living polystyryl anion of M.W. 26,000 was prepared from the addition of n-Butyllithium in cyclohexane to the solution of cyclohexane (24 ml), styrene (1 ml) and tetrahydrofuran (100 μl) under argon atmosphere. Divinylbenzene was added to living polystyryl anion at once. After finishing the reaction, the reaction mixture was precipitated with methanol to give star polystyrene. Molecular weight of star polystyrene was determined by gel permeation chromatography using laser light-scattering detector. As shown in Table 1 and FIG. 1, one shot addition of divinylbenzene to living polystyryl anion resulted in the formation of 21˜32% of unreacted polystyrene.

TABLE 1
Star polystyrene prepared by one shot addition of divinylbenzene

| | Molecular | | Linking | | |
|---|---|---|---|---|---|
| [DVB]/ | weight (×10⁴) | | efficiency | Poly- | Number of |
| [PSLi] | Polystyrene | (PS)ₙX | (%) | dispersity | arms |
| 1.7 | 2.6 | 42.3 | 68 | 1.05 | 16 |
| 3.4 | 2.6 | 54.1 | 75 | 1.05 | 21 |
| 5.1 | 2.6 | 69.5 | 79 | 1.08 | 27 |

### Example 1

### Star Polystyrenes Prepared by the Incremental Addition of Divinylbenzene

Living polystyryl anion of M.W. 26,000 was prepared as described in Comparative Example 1. Divinylbenzene was repeatedly added to living polystyryl anion. After finishing the reaction, the reaction mixture was precipitated with methanol to give star polystyrene. Molecular weight of star polymer was determined by gel permeation chromatography using laser light-scattering detector. As shown in Table 2 and FIG. 1, incremental addition of divinylbenzene to living polystyryl anion afforded star polystyrene in the linking efficiency of 99%.

TABLE 2
Star polystyrenes prepared by incremental addition of
divinylbenzene

| | Molecular | | Linking | | Number |
|---|---|---|---|---|---|
| | weight (×10⁴) | | efficiency | Poly- | of |
| [DVB]/[PSLi] | Polystyrene | (PS)ₙX | (%) | dispersity | arms |
| 0.74 × 2 (1.5) | 2.6 | 31.2 | 93 | 1.05 | 12 |
| 0.74 × 5 (3.7) | 2.6 | 67.3 | 98 | 1.07 | 26 |
| 0.74 × 7 (5.2) | 2.6 | 88.8 | 99 | 1.09 | 34 |

FIG. 1 shows gel permeation chromatography of star polystyrenes (A, B, C) prepared by incremental addition of divinylbenzene to polystyryl anion of M.W. 26,000 according to the methods of Example 1.

Star polystyrene A is prepared by twice addition of 0.74 equivalent each of divinylbenzene; star polystyrene B is prepared by 5 times addition of 0.74 equivalent each of divinylbenzene; and star polystyrene C is prepared by 7 times addition of 0.74 equivalent each of divinylbenzene.

Gel permeation chromatography of star polystyrene (D, E, F) prepared by one shot addition of divinylbenzene to polystyryl anion of M.W. 26,000 according to the methods of Comparative Example 1 are also shown in FIG. 1.

Star polystyrene D is prepared by one shot addition of 1.7 equivalent of divinylbenzene; star polystyrene E is prepared by one shot addition of 3.4 equivalent of divinylbenzene; and star polystyrene F is prepared by one shot addition of 5.1 equivalent of divinylbenzene.

### Comparative Example 2

### Star Polystyrenes Prepared by One Shot Addition of Divinylbenzene (DVB)

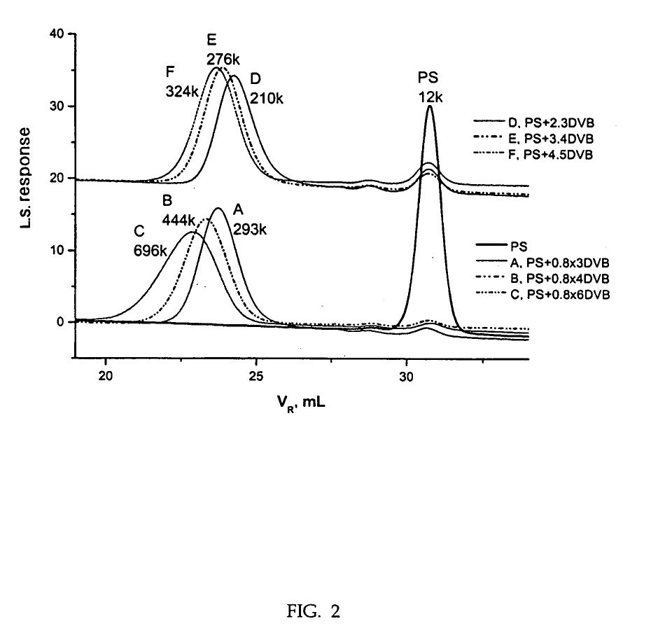

Living polystyryl anion of M.W. 11,000 was prepared as described in Comparative Example 1. Divinylbenzene was added to living polystyryl anion at once. After finishing the reaction, the reaction mixture was precipitated with methanol to give star polystyrene. Molecular weight of star polymer was determined by gel permeation chromatography using refractive index- or/and laser light-scattering detector. As shown in Table 3 and FIG. 2, one shot addition of divinylbenzene to living polystyryl anion resulted in the formation of 9˜12% of unreacted polystyrene.

TABLE 3
Star polystyrenes prepared by one shot addition of DVB

| | Molecular | | Linking | | |
|---|---|---|---|---|---|
| | weight (×10⁴) | | efficiency | Poly- | Number of |
| [DVB]/[PSLi] | PS | (PS)ₙX | (%) | dispersity | arms |
| 2.3 | 1.1 | 21.0 | 88 | 1.05 | 19 |
| 3.4 | 1.1 | 27.6 | 91 | 1.05 | 25 |
| 4.5 | 1.1 | 32.4 | 89 | 1.06 | 30 |

### Example 2

### Star Polystyrenes Prepared by Incremental Addition of Divinylbenzene (DVB)

Living polystyryl anion of M.W. 12,000 was prepared as described in Comparative Example 1. Divinylbenzene was repeatedly added to living polystyryl anion. After finishing the reaction, the reaction mixture was precipitated with methanol to give star polystyrenes. Molecular weight of star polystyrene was determined by gel permeation chromatography using laser light-scattering detector. As shown in Table 4 and FIG. 2, incremental addition of divinylbenzene to living polystyryl anion afforded star polystyrene in the linking efficiency of more than 95%.

TABLE 4
Star polystyrenes prepared by incremental addition of DVB

| | Molecular | | Linking | | |
|---|---|---|---|---|---|
| | weight (×10⁴) | | efficiency | Poly- | Number of |
| [DVB]/[PSLi] | PS | (PS)ₙX | (%) | dispersity | arms |
| 0.81 × 3 (2.4) | 1.2 | 29.3 | 95 | 1.07 | 24 |
| 0.81 × 4 (3.2) | 1.2 | 44.4 | 96 | 1.08 | 37 |
| 0.81 × 6 (4.9) | 1.2 | 69.6 | 96 | 1.09 | 58 |

FIG. 2 shows gel permeation chromatography of star polystyrenes (A, B, C) prepared by incremental addition of divinylbenzene to polystyryl anion of M.W. 12,000 according to the methods of Example 2.

Star polystyrene A is prepared by 3 times addition of 0.81 equivalent each of divinylbenzene; star polystyrene B is prepared by 4 times addition of 0.81 equivalent each of divinylbenzene; and star polystyrene C is prepared by 6 times addition of 0.81 equivalent each of divinylbenzene.

Gel permeation chromatography of star polystyrenes (D, E, F) prepared by one shot addition of divinylbenzene to polystyryl anion of M.W. 11,000 according to the methods of Comparative Example 2 are also shown in FIG. 1.

Star polystyrene D is prepared by one shot addition of 2.3 equivalent of divinylbenzene; star polystyrene E is prepared by one shot addition of 3.4 equivalent of divinylbenzene; and star polystyrene F is prepared by one shot addition of 4.5 equivalent of divinylbenzene.

### Comparative Example 3

### Star Polystyrenes Prepared by One Shot Addition of Divinylbenzene (DVB)

Living polystyryl anion of M.W. 2,500 or 117,000 was prepared as described in Comparative Example 1. Divinylbenzene was added to living polystyryl anion at once. After finishing the reaction, the reaction mixture was precipitated with methanol to give star polystyrenes. Molecular weight of star polystyrene was determined by gel permeation chromatography using refractive index detector. As shown in Table 5, one shot addition of divinylbenzene to living polystyryl anion of M.W. 2,500 or 117,000 resulted in the formation of 7˜13% of unreacted polystyrene.

TABLE 5
Star polystyrenes prepared by one shot addition of DVB

| | | | Linking | |
|---|---|---|---|---|
| | Molecular weight(×10⁴) | | efficiency | Number of |
| [DVB]/[PSLi] | PS | (PS)ₙX | (%) | arms |
| 1.9 | 0.25 | 3.5 | 98 | 14 |
| 2.8 | 0.25 | 8.8 | 89 | 35 |
| 3.8 | 0.25 | 196.2, 90.2, 32.0 | 98 (1:1:2) | 774, 361, 128 |
| 4.7 | 0.25 | gel | — | — |
| 20 | 11.7 | 188.4 | 93 | 16 |
| 30 | 11.7 | 213.3 | 87 | 18 |
| 40 | 11.7 | 226.0 | 91 | 19 |

### Example 3

### Star Polystyrenes Prepared by Incremental Addition of Divinylbenzene (DVB)

Living polystyryl anion of M.W. 116,000 or 9,000 was prepared as described in Comparative Example 1. Divinylbenzene was repeatedly added to living polystyryl anion. After finishing the reaction, the reaction mixture was precipitated with methanol to give star polystyrenes. Molecular weight of star polymer was determined by gel permeation chromatography using refractive index detector. As shown in Table 6, incremental addition of divinylbenzene to living polystyryl anion of M.W. 116,000 or 9,000 afforded star polystyrene in the linking efficiency of more than 98%.

TABLE 6
Star polystyrenes prepared by incremental addition of DVB

| | | | Linking | |
|---|---|---|---|---|
| | Molecular weight(×10⁴) | | efficiency | Number of |
| [DVB]/[PSLi] | PS | (PS)ₙX | (%) | arms |
| 2.1 × 1 (2.1) | 11.6 | 76.6 | 78 | 7 |
| 2.1 × 2 (4.2) | 11.6 | 108.3 | 84 | 9 |
| 2.1 × 3 (6.3) | 11.6 | 119.6 | 84 | 10 |
| 2.1 × 4 (8.4) | 11.6 | 129.4 | 90 | 11 |
| 1.6 × 1 (1.6) | 4.6 | 26.2 | 88 | 6 |
| 1.6 × 2 (3.2) | 4.6 | 36.1 | 96 | 8 |
| 1.6 × 3 (4.8) | 4.6 | 50.5 | 96 | 11 |
| 3.9 × 1 (3.9) | 2.9 | 16.5 | 72 | 6 |
| 3.9 × 2 (7.8) | 2.9 | 21.3 | 94 | 7 |
| 3.9 × 3 (11.7) | 2.9 | 23.5 | 96 | 8 |
| 0.36 × 1 (0.4) | 0.9 | 3.7 | 21 | 4 |
| 0.36 × 3 (1.1) | 0.9 | 7.5 | 80 | 8 |
| 0.36 × 7 (2.5) | 0.9 | 10.8 | 98 | 12 |

As a conclusion, the method for preparing star polymer of present invention can control the number of arms, as well as minimize the formation of gel polymer and unreacted linear polymer.

### Example 4

### Preparation of Multiple Star Polystyrene

Living polystyryl anion of M.W. 2,500 was prepared as described in Comparative Example 1. Divinylbenzene was repeatedly added to living polystyryl anion. After finishing the reaction, the reaction mixture was precipitated with methanol to give multiple star polystyrene. Molecular weight of multiple star polystyrene was determined by gel permeation chromatography using laser light-scattering detector. As shown in Table 7, incremental addition of 0.65 equivalent of divinylbenzene to living polystyryl anion of M.W. 2,500 afforded multiple star polystyrene of M.W. 76,500 in the linking efficiency of more than 97% through star-star coupling.

TABLE 7
Preparation of multiple star polystyrene

| | | | Linking | | |
|---|---|---|---|---|---|
| | Mw (×10³) | | efficiency | Poly- | Number of |
| [DVB]/[PSLi] | PS | (PS)ₙX | (%) | dispersity | branches |
| 0.65 × 1 (0.7) | 2.5 | 13.5 | 57 | 1.13 | 5.5 |
| 0.65 × 2 (1.3) | 2.5 | 29.4 | 89 | 1.17 | 12.0 |
| 0.65 × 3 (2.0) | 2.5 | 76.5 | 97 | 1.23 | 31.1 |

### Example 5

### Preparation of Multiple Star Polystyrene

Living polystyryl anion of M.W. 2,800 was prepared as described in Comparative Example 1. Divinylbenzene was repeatedly added to living polystyryl anion. After finishing the reaction, the reaction mixture was precipitated with methanol to give multiple star polystyrene. Molecular weight of multiple star polystyrene was determined by gel permeation chromatography using laser light-scattering detector. As shown in Table 8, incremental addition of 0.71 equivalent of divinylbenzene to living polystyryl anion of M.W. 2,800 afforded multiple star polystyrene of M.W. 91,000 in the linking efficiency of more than 95% through star-star coupling.

TABLE 8
Preparation of multiple star polystyrene

| | | | Linking | | |
|---|---|---|---|---|---|
| | Mw (×10³) | | efficiency | Poly- | Number of |
| [DVB]/[PSLi] | PS | (PS)ₙX | (%) | dispersity | branches |
| 0.71 × 1 (0.7) | 2.8 | 14 | 60 | 1.17 | 5.1 |
| 0.71 × 2 (1.4) | 2.8 | 37 | 90 | 1.27 | 13.4 |
| 0.71 × 3 (2.1) | 2.8 | 91 | 95 | 1.18 | 33.2 |

### Example 6

### Preparation of Multiple Star Polystyrene

Living polystyryl anion of M.W. 12,000 was prepared as described in Comparative Example 1. Divinylbenzene was repeatedly added to living polystyryl anion. After finishing the reaction, the reaction mixture was precipitated with methanol to give multiple star polystyrene. Molecular weight of multiple star polystyrene was determined by gel permeation chromatography using laser light-scattering detector. As shown in Table 9, incremental addition of 0.81 equivalent of divinylbenzene to living polystyryl anion of M.W. 12,000 afforded multiple star polystyrene of M.W. 293,000 in the linking efficiency of more than 95% through star-star coupling.

TABLE 9
Preparation of multiple star polystyrene

| | | | Linking | | |
|---|---|---|---|---|---|
| | Mw (×10⁴) | | efficiency | Poly- | Number of |
| [DVB]/[PSLi] | PS | (PS)ₙX | (%) | dispersity | branches |
| 0.81 × 1 (0.8) | 1.2 | 8.1 | 54 | 1.07 | 6.8 |
| 0.81 × 2 (1.6) | 1.2 | 18.2 | 93 | 1.08 | 15.2 |
| 0.81 × 3 (2.4) | 1.2 | 29.3 | 95 | 1.07 | 24.4 |

1. A method for preparing star polymer comprising the steps of:
i) preparing living polymer anion having molecular weight of 500˜500,000 by reacting anionic polymerization initiator with at least one monomer selected from the group consisting of styrene, α-methylstyrene, ο-methylstyrene, p-methylstyrene, p-tert-butylstyrene, butadiene, isoprene, and cyclohexadiene;
ii) repeatedly adding more than twice at least one linking agent selected from the group consisting of divinylbenzene, divinyltoluene, divinylbiphenyl and divinylnaphthalene to prepare star polymer.

2. The method for preparing star polymer according to claim 1, wherein said monomer is at least one selected from the group consisting of styrene, butadiene, and isoprene.

3. The method for preparing star polymer according to claim 1, wherein said anionic polymerization initiator is at least one selected from the group consisting of n-butyllithium, sec-butyllithium, tert-butyllithium, methyllithium, and ethyllithium.

4. The method for preparing star polymer according to claim 1, wherein said anionic polymerization initiator is n-butyllithium.

5. The method for preparing star polymer according to claim 1, wherein said linking agent is divinylbenzene.

6. The method for preparing star polymer according to claim 1, wherein said living polymer anion is at least one selected from the group consisting of polystyrene-polybutadiene block copolymer, polystyrene-polyisoprene block copolymer, styrene-butadiene random copolymer, and styrene-isoprene random copolymer.

7. The method for preparing star polymer according to claim 1, wherein total amount of linking agent is 0.1˜10 molar equivalent relative to living polymer anion and the each amount of linking agent per one addition is 0.1˜2 molar equivalent relative to living polymer anion.

8. The method for preparing star polymer according to claim 1, wherein molecular weight of said living polymer anion is 2,000˜200,000.

9. The method for preparing star polymer according to claim 1, wherein molecular weight of said star polymer is 10,000˜5,000,000.

10. Star polymer prepared by the method according to claim 1.

11. A multiple star polymer with following formula 1;
SₚX_{q}Aᵣ (1)
wherein,
S is a star polymer represented by formula Aₘ-Xₙ,
A is a polymer branch of molecular weight of 500˜100,000,
X is a linking agent represented by formula (Y-Z-Y),
[Y is a vinyl group in the form of (—CR₁═CR₂R₃), wherein R₁, R₂ or R₃ is each independently H, C 1˜20 alkyl, Z is an aromatic compound, such as benzene, biphenyl, toluene or naphthalene]
m is an integer of 3˜100, n is an integer of 1˜100,
whereas 0.1<n/m<10,
p is an integer of 2˜1000, q is an integer of 2˜100,
r is an integer of 0˜100, whereas (p+r)<q.

12. The multiple star polymer according to claim 11, wherein said polymer branch is homopolymer selected from the group consisting of polystyrene, poly(α-methylstyrene), poly(o-methylstyrene), poly(p-methyl-styrene), poly(p-tert-butylstyrene), polybutadiene, polyisoprene, and polycyclohexadiene.

13. The multiple star polymer according to claim 11, wherein said polymer branch is copolymer of at least two monomers selected from the group of vinyl aromatic monomer, such as, styrene, α-methylstyrene, o-methylstyrene, p-methylstyrene, p-tert-butylstyrene and conjugated-diene monomer, such as, butadiene, isoprene, cyclohexadiene.

14. The multiple star polymer according to claim 13, wherein said copolymer is a block copolymer consisting of more than 2 polymer blocks selected from polystyrene block, polybutadiene block, or polyisoprene block.

15. The multiple star polymer according to claim 13, wherein said copolymer is a random copolymer of more than 2 monomers selected from styrene, butadiene, or isoprene.

16. The multiple star polymer according to claim 12, wherein said homopolymer is polystyrene, polybutadiene, or polyisoprene.

17. The multiple star polymer according to claim 11, wherein said linking agent is at least one selected from the group consisting of divinylbenzene, divinyltoluene, divinylbiphenyl, and divinylnaphthalene.

18. A process for preparing multiple star polymer represented by formula 1 comprising the steps of:
i) preparing for living polymer anion with molecular weight of 500˜100,000 by the addition of anionic polymerization initiator to at least one monomer selected from the group consisting of vinyl aromatic monomer, such as, styrene, α-methylstyrene, o-methylstyrene, p-methylstyrene, p-tert-butyl-styrene and conjugated-diene monomer, such as, butadiene, isoprene, cyclohexadiene;
ii) preparing for living star polymer anion by the addition of the linking agent of formula (Y-Z-Y) to obtained living polymer anion; and
iii) preparing for multiple star polymer by adding more than once the linking agent of formula (Y-Z-Y) to obtained living star polymer anion.
SₚX_{q}Aᵣ (1)
wherein,
S is a star polymer represented by formula Aₘ-Xₙ,
A is a polymer branch of M.W. 500˜100,000,
X is a linking agent represented by formula (Y-Z-Y),
[Y is a vinyl group in the form of (—CR₁═CR₂R₃), wherein R₁, R₂ or R₃ is each independently H, C 1˜20 alkyl, Z is an aromatic compound, such as benzene, biphenyl, toluene, or naphthalene]
m is an integer of 3˜100, n is an integer of 1˜100,
whereas 0.1<n/m<10,
p is an integer of 2˜1000, q is an integer of 2˜100,
r is an integer of 0˜100, whereas (p+r)<q.

19. The process for preparing multiple star polymer according to claim 18, wherein said anionic polymerization initiator is at least one selected from the group consisting of n-butyllithium, sec-butyllithium, tert-butyllithium, methyllithium, and ethyllithium.

20. The process for preparing multiple star polymer according to claim 18, wherein the amount of linking agent is 0.1˜3 molar equivalent relative to living polymer anion.

21. The method for preparing star polymer according to claim 18, wherein the same or different amount of linking agent is repeatedly added to the living polymer anion.

22. The process for preparing multiple star polymer according to claim 18, wherein the molecular weight of said living polymer anion is 1,000˜20,000.

23. The process for preparing multiple star polymer according to claim 20, wherein the amount of linking agent is 0.1˜2 molar equivalent relative to living polymer anion.

24. The process for preparing multiple star polymer according to claim 18, wherein the linking agent is added more than twice relative to living polymer anion.
